(19) United States
(12) Patent Application Publication
(10) Pub. No.: US 2016/0332599 A1
(43) Pub. Date: Nov. 17, 2016

(54) WINDSHIELD WIPER SYSTEM WITH ADAPTIVE CURVATURE

(71) Applicant: VOLVO TRUCK CORPORATION, Göteborg (SE)

(72) Inventors: Joseph Thomas BARRETTA, Greensboro, NC (US); Frida WIJKÖ, Gothenburg (SE); Gareth Howard SPENSLEY, High Point, NC (US)

(73) Assignee: VOLVO TRUCK CORPORATION, Göteborg (SE)

(21) Appl. No.: 15/111,261

(22) PCT Filed: Jan. 24, 2014
(86) PCT No.: PCT/US14/12849

§ 371 Date: Jul. 13, 2016

(51) Int. Cl. B60S 1/34; B60S 1/04

(52) U.S. Cl. CPC B60S 1/3486; B60S 1/0438; B60S 1/3406; B60S 1/3495

(57) ABSTRACT

A windshield wiper system and a vehicle having the same, where the windshield wiper system has a wiper blade rotating about a first pivot. The wiper blade includes an inner blade portion hinged to an outer blade portion. A flexible wiper is supported by the inner and outer blade portions. A deflector is formed on the outer blade portion. A control bar rotates about a second pivot that is spaced apart from the first pivot. The control bar has an actuator for engaging with the deflector. The actuator is capable of translating relative to the deflector in order for the actuator to selectively apply a force to the deflector during rotation of the wiper blade and control bar. The application of the force causes a torque about the hinge between the inner and outer blade portions. The torque allows the outer blade portion to follow the contour of a windshield.

### FIELD OF INVENTION

This disclosure relates to the art of windshield wiper systems. Particularly this disclosure relates wiper systems for cleaning curved surfaces.

### BACKGROUND

Drivers often encounter conditions restricting their view of the path ahead. Heavy rain or snow can build up on a vehicle's windshield, impairing the driver's vision. Surrounding vehicles may project water or other debris from the road onto the windshield. The windshield can also become soiled with insects, bird droppings or other organic material. The ability to properly remove these items from the driver's field of view is an important aspect of the safe operation of vehicles.

Numerous wiper configurations and control mechanisms have been developed in an attempt to clear as much of the area in front of the driver as possible. Available configurations are often classified into several categories: “tandem” systems with dual blades acting in the same direction; “opposed” systems with dual blades acting in opposite directions; and “single” systems that rely upon only one blade. Systems in each category create a different wiping pattern with their own advantages and disadvantages.

In some cases, existing wiper blades do not effectively use the full sweep angle of the respective blades because the blades may lose contact with the surface of the windshield. This loss of net cleaned area is especially apparent with complex curved windshields. For example, the lateral edges of the windshield may have a smaller radius of curvature than the remainder of the windshield due to the design of the vehicle cab and windshield frame.

Therefore, there remains a need for a windshield wiper system capable of a large cleaning area over a windshield with complex curved surface portions. There also is a need for such a system that uses an efficient system design that can be manufactured and produced in a cost effective manner.

### SUMMARY

The present disclosure includes a windshield wiper system comprising: a wiper blade configured to rotate about a first pivot, the wiper blade including an inner blade hinged to an outer blade, the inner and outer blade supporting a flexible wiper, a deflector formed on the outer blade; and a control bar configured to rotate about a second pivot spaced apart from the first pivot, the control bar having an actuator capable of engaging with the deflector, wherein the actuator translates relative to the deflector such that the actuator selectively applies a force to the deflector during rotation of the wiper blade and control bar causing a torque about the hinge, the torque allowing the outer blade to follow the contour of a windshield.

The present disclosure also includes a vehicle comprising: a passenger cabin; a windshield; a windshield wiper system; and at least one motor for operating the windshield wiper system, wherein the windshield wiper system comprises: a wiper blade configured to rotate about a first pivot, the wiper blade including an inner blade hinged to an outer blade, the inner and outer blade supporting a flexible wiper, a deflector formed on the outer blade; and a control bar configured to rotate about a second pivot spaced from the first pivot, the control bar having an actuator capable of engaging with the deflector, wherein the actuator translates relative to the deflector such that the actuator selectively applies a force to the deflector during rotation of the wiper blade and control bar causing a torque about the hinge, the torque allowing the outer blade to follows the contour of a windshield.

These and other aspects of the present invention will become apparent to those skilled in the art after a reading of the following description of the preferred embodiments, when considered in conjunction with the drawings. It should be understood that both the foregoing general description and the following detailed description are explanatory only and are not restrictive of the invention as claimed.

### BRIEF DESCRIPTION OF THE DRAWINGS

FIG. 1 shows a front perspective view of a vehicle having a first embodiment of a wiper system of the present disclosure.

FIG. 2 shows a front view of a windshield with the first embodiment of the wiper system of the present disclosure.

FIG. 3A shows a side view of a wiper blade of the present disclosure in a neutral position at location “A” in FIG. 2.

FIG. 3B shows a side view of a wiper blade of the present disclosure in a neutral position at location “B” in FIG. 2.

FIG. 3C shows a side view of a wiper blade of the present disclosure in a bent position at location “C” in FIG. 2.

FIG. 4 shows a front view of a windshield with a second embodiment of the wiper system of the present disclosure.

FIG. 5 shows a front view of a windshield with a third embodiment of the wiper system of the present disclosure.

### DETAILED DESCRIPTION OF THE DRAWINGS

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the present invention. Features from one embodiment or aspect may be combined with features from any other embodiment or aspect in any appropriate combination. For example, any individual or collective features of method aspects or embodiments may be applied to apparatus, product or component aspects or embodiments and vice versa.

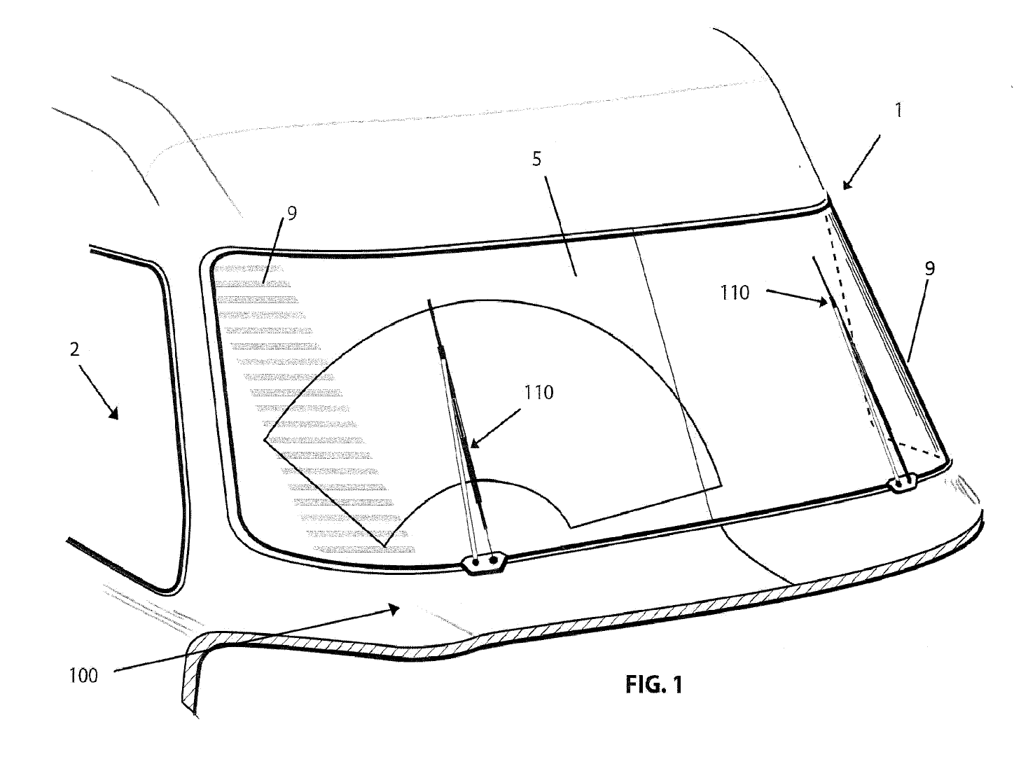

Turning to the figures, FIG. 1 shows a partial front perspective view of a vehicle 1, such as a commercial truck, having a windshield 5, at the front of a passenger cabin 2. The windshield 5 includes end regions 9 (shaded) having an increased degree of curvature relative to the central area of the windshield 5. Generally, vehicle manufacturers may desire to vary the windshield curvature for reasons such as aerodynamics or aesthetics.

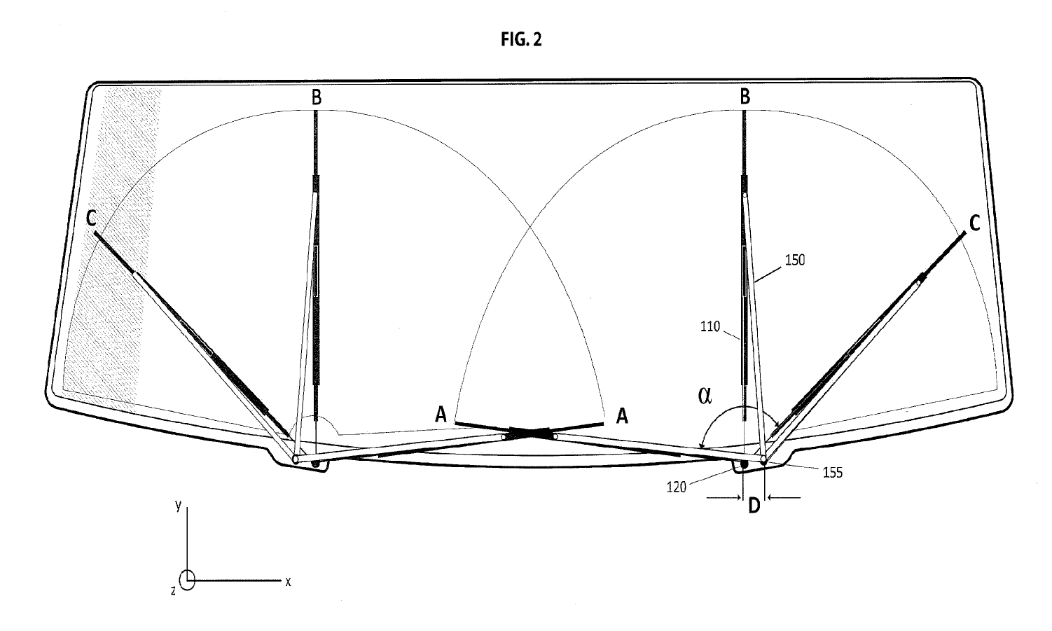

The end regions 9 are defined as being at opposed ends of the windshield 5, relative to the vehicle 1 along a lateral axis. The lateral axis is shown by the X axis of FIG. 2, which is the direction generally perpendicular to the normal direction of travel. The lateral axis defines an inward and outward direction, with items outward being closer to the ends and items inward being closer to the center of the vehicle or windshield. The vertical axis is shown by the y-axis of FIG. 2. An upright direction is defined as the direction along the y-axis away from the ground, and a downward direction is defined as the direction along the Y-axis toward the ground. The longitudinal axis is shown by the z-axis of FIG. 2. The longitudinal axis defines the forward and rearward directions relative to the vehicle as used in this disclosure. As used herein, the terms “offset” and “spaced apart” are used to describe the relationship of “pivots.” Two “pivots” are “offset” or “spaced apart” if the axis of rotation of the first pivot is not substantially co-linear with the axis of rotation of the second pivot.

The windshield 5 is cleared by a wiper system, generally indicated as 100. While the wiper system 100 is intended for use on windshields 5 with complex end regions 9 as described above, but this disclosure is not limited thereto. The wiper system 100 of this disclosure may also be used on windshields 5 that are flat, substantially flat, or having a generally consistent radius of curvature throughout.

The wiper system 100 includes at least one wiper blade 110. In some embodiments, the wiper system 100 includes a pair of wiper blades 100. FIG. 1 shows a pair of wiper blades 110 in their initial, stored position. As will be understood by one skilled in the art, the illustrated wiper system 100 is an “opposed” type wiper system. The wiper blades 110 are understood to travel in opposite directions while in motion. For example, from the perspective of the driver, the driver's side wiper blade will initially sweep in a counter-clockwise direction and return in a clockwise direction. On the other hand, the passenger's side wiper blade will initially sweep in a clockwise direction and return in a counter-clockwise direction. As seen in FIG. 1, the wiper blades 110 preferably overlap each other along the vehicle lateral direction. The overlap helps minimize the unswept area in the center of the windshield 5. In other embodiments, the wiper blades 110 may be spaced apart, not overlapping in their initial position. This spaced-apart arrangement could be used if the windshield 5 comprised two separate panes separated by a central frame member.

Turning to FIG. 2, a front view of the windshield 5 with an opposed type wiper system 100 is shown. Each wiper blade 110 should be understood to sweep through an arc that includes an initial position A, an intermediate, substantially upright position B, and at an extended position C. The terms “initial,” “intermediate and “extended” should be understood as merely identifiers for the purpose of describing the wiper system 100 and not adjectives intended to limit the scope of the invention. For instance, one skilled in the art will understand that wiper systems very often provide a first pass in one direction followed by a return pass in the opposite direction. Therefore the initial position is simply the “A” position relative to the windshield 5 of the present disclosure without consider of whether the wiper blade 110 is leaving position A or returning to position A.

In some embodiments, the wiper blade 110 in the extended position C forms an angle a with the wiper blade 110 at the initial position A of about 100 to about 130 degrees, preferably about 110 degrees. Those skilled in the art will understand that the range of angles sweep by the wiper blade 110 would be different for non-opposed wiper systems.

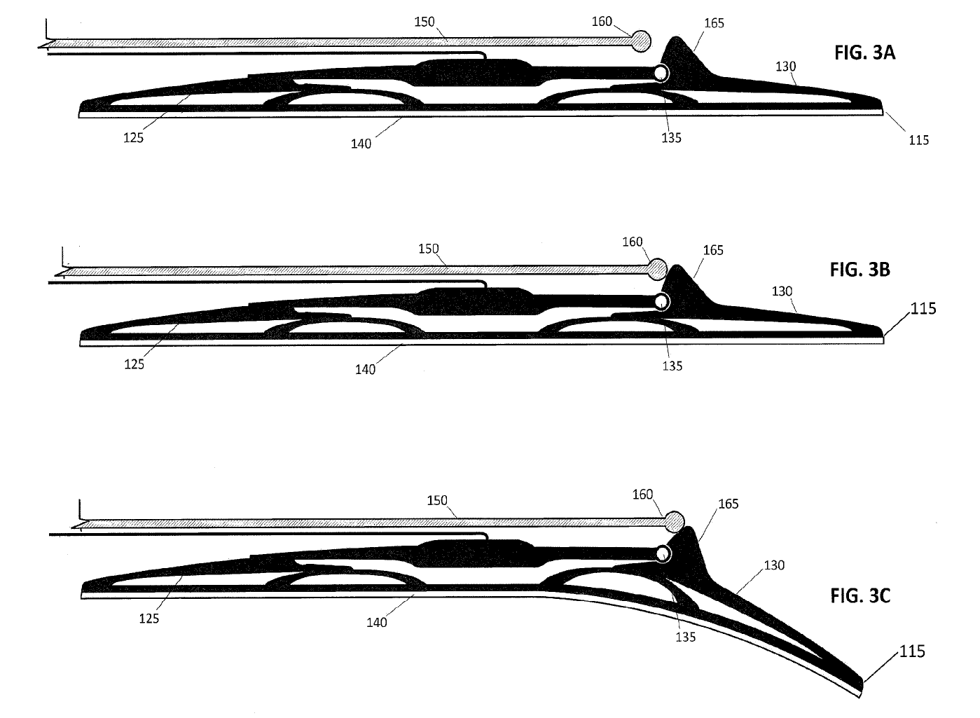

Each wiper blade 110 rotates about a first pivot 120. In some embodiments, the first pivot 120 will include an axle (not shown) that is selectively rotated, directly or indirectly, by a motor (not shown). As best seen in FIG. 3, each wiper blade 110 includes a first, radially inner blade 125 and a second, radially outer blade 130. The radially inner blade 125 being the portion that is closer the pivot axle of the first pivot 120 and the radially outer blade 130 being the portion that is further from the pivot axle of the first pivot 120. The inner blade 125 may be directly or indirectly connected to the first pivot 120. The inner blade 125 and the outer blade 130 are connected by a hinge 135 that allows the outer blade 130 to rotate with respect to the inner blade 125. The axis of rotation about the hinge 135 is substantially tangential to the axis of rotation about the first pivot 120. In other words, the outer blade 130 pivots in a plane generally perpendicular to a first pass swept by the inner blade 125. In some embodiments, the hinge 135 is configured to provide the outer blade 130 with a limited range of rotational motion. Particularly, the outer blade 130 can be prevented from pivoting past a position co-planar with the inner blade 125 in a direction away from the windshield 5.

The inner blade 125 and the outer blade 130 provide a support frame for a flexible wiper 140. In some embodiments, the flexible wiper 140 is a unitary strip of flexible or elastomeric material capable of cleaning debris and liquid from the surface of the windshield 5. In some embodiments, the inner and outer blades 125, 130 support a single flexible wiper 140, but in other embodiments each of the inner blade 125 and the outer blade 130 have a separate respective flexible wiper 140.

Each wiper blade 110 is paired with a control bar 150. The control bar 150 rotates with respect to a second pivot 155. The second pivot 155 is spaced from the first pivot 120. In an embodiment, the first pivot 120 is offset from the second pivot 155 by a distance d of between about 1 cm and about 20 cm measured between the pivot centers. As seen in FIG. 2, with respect to the opposed type wiper system 100, the second pivot 155 is located outward of the first pivot 120 with respect to the lateral axis of the vehicle 1. The control bar 150 can include an axle powered to rotate in conjunction with the wiper blade 110, or may rotate on a dummy axle actuated solely by the force of the wiper blade's rotation.

As best understood from FIGS. 3A-C, an actuator 160 of the control bar 150 will translate relative to the hinge 135 as the wiper blade 110 rotates along with the control bar 150 from the initial position A, to the intermediate position B and finally to the extended position C. The wiper blade 110 may include a guide (not shown), such as a ring, through which the control bar 150 is able to slide. The guide can allow relative motion between the hinge 135 and the actuator 160, but can help prevent the control bar 150 from becoming disassociated with the rotation of the wiper blade 110. As seen in FIGS. 3A-C, the outer blade 130 may include a deflector 165 for selectively engaging the actuator 160 of the control bar 150. In the initial position A, the actuator 160 may terminate prior to touching the deflector 165, see FIG. 3A. Thus the control bar 150 may not influence the position of the outer blade 130 when the wiper blade 110 is in the initial position A. In the intermediate position B, the actuator 160 may terminate adjacent to the deflector 165, but prior to applying a force thereto, see FIG. 3B. Again, control bar 150 will have minimal if any influence on the position of the outer blade 130 relative to the inner blade 125. In extended position C, of the embodiment illustrated in FIG. 2, the actuator 160 reaches a point of maximum displacement radially outward of the hinge 135, see FIG. 3C. The actuator 160 engages the deflector 165, creating a torque about the hinge 135, and causing the outer blade 130 to attempt rotation about the hinge 135. As will be understood by one skilled in the art, the wiper blades 110, and control bars 150, sweep a continuous arc from the initial position A to the extended position C (and back again), such that intermediate position B is solely one example of a position along the arc. Further, it will be understood that the relative positions of the actuator 160 and the hinge 135 or deflector 165 will also vary continuously as the wiper blade 110 and control bar 150 sweep through the arc. One skilled in the art will also recognize that the range of displacement between the actuator 160 and the hinge 135 can be controlled by adjusting the offset distance d as well as the lengths of the control bar 150 and the wiper blades 110 relative to their respective pivots.

In embodiments of the present disclosure, the extended position C corresponds to placement of the outer blade 130 in association with the end region 9 of the windshield 5. The force of the actuator 160 against the deflector 165 will cause the outer blade 130 to form an angle with the inner blade 125, helping to maintain contact with the underlying windshield end region 9. In some embodiments, the inner blade 125 will form an angle with the outer blade 130 of between about 140 degrees and about 175 degrees when the wiper blade 110 is in the extended position C.

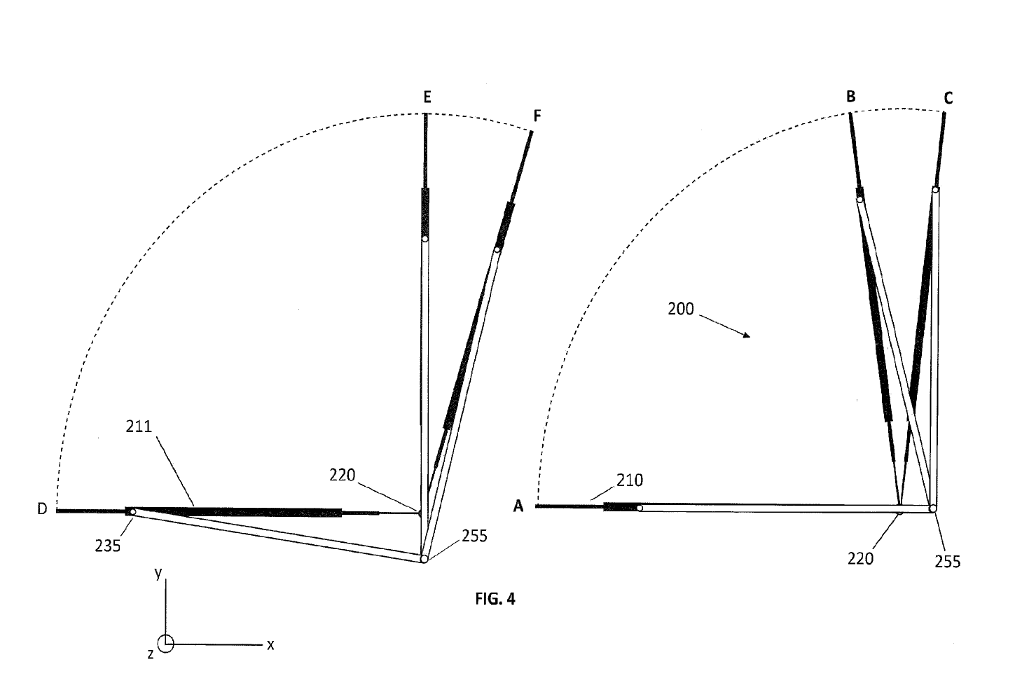

Turning to FIG. 4, a tandem wiper system 200 is shown. The tandem wiper system 200 includes two wiper blades 210, 211 of the same structure as discussed above with respect to wiper blade 110. The first wiper blade 210, sweeps through positions A, B and C and is substantially identical to one of the wiper blades 110 within the opposed wiper system 100. The second wiper blade 211 is configured to rotate in the same direction as the first wiper blade 210. The second wiper blade 211 will experience a different windshield profile at each position than the first wiper blade 210. In the second wiper blade initial position D, the second wiper blade 211 should be bent as shown in FIG. 3C. In the second wiper blade intermediate position E, and second wiper blade extended position F, the second wiper blade 211 should be substantially linear as shown in FIGS. 3A and 3B. To achieve this result, the second pivot 255 should be offset downwardly or forwardly in the YZ plane relative to the first pivot 220, as shown in FIG. 4. This relative positioning of the first and second pivots 220, 255 will place the actuator most radially outward (with respect to the hinge) at position D, most radially inward at position E and sufficiently radially inward at position F to maintain a substantially co-planar wiper blade 211. FIG. 4 shows the first wiper blade 210 distanced from the second wiper blade 211 such that their respective coverage areas do not overlap. One skilled in the art would understand this is only one possible arrangement, and that the wiper blades 210, 211 may be lengthened or positioned closer together to minimize the un-swept area of the windshield.

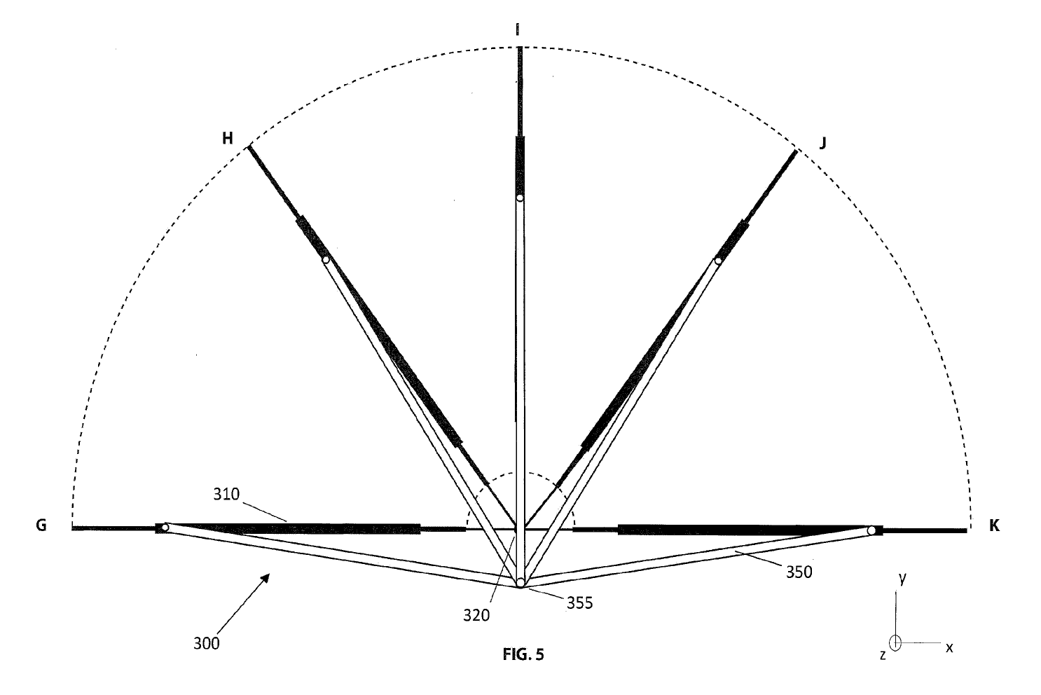

Turning to FIG. 5, a single wiper system 300 is shown. The single wiper system 300 includes a single wiper blade 310 capable of sweeping approximately 180 degrees. The single wiper blade 310 is substantially similar to wiper blade 110 discussed above. As seen in FIG. 5, the single wiper system 300 includes an initial position G, a series of intermediate positions H-J, and an extended position K opposite to the initial position G. The single wiper system 300 will operate the same regardless of whether G is the initial position or the wiper blade 310 starts at the extended position K. In order for the single wiper system 300 to clean the same windshield 5 with heavily curved end regions 9 as referenced in FIGS. 1, 2 and 4, the single wiper blade 310 should be bent (FIG. 3B) at positions G and K, and be substantially linear (FIGS. 3A and 3B) at positions H-J. To achieve this result, the second pivot 355 is offset downwardly or forwardly in the YZ plane relative to the first pivot 320. This relative positioning of the first and second pivots 320, 355 will place the actuator most radially outward (with respect to the hinge) at positions G and K, most radially inward at position I and sufficiently radially inward at positions H and J to maintain a substantially co-planar single wiper blade 310.

Although the above disclosure has been presented in the context of exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

We claim:

1. A windshield wiper system comprising:
a wiper blade configured to rotate about a first pivot, the wiper blade including an inner blade hinged to an outer blade, the inner and outer blade supporting a flexible wiper, a deflector formed on the outer blade; and
a control bar configured to rotate about a second pivot spaced apart from the first pivot, the control bar having an actuator capable of engaging with the deflector,
wherein the actuator translates relative to the deflector such that the actuator selectively applies a force to the deflector during rotation of the wiper blade and control bar causing a torque about the hinge, the torque allowing the outer blade to follow the contour of a windshield.

2. The windshield wiper system according to claim 1, further comprising:
a second wiper blade configured to rotate about a third pivot, the second wiper blade having an inner blade hinged to an outer blade having a deflector, the inner blade and outer blade supporting a flexible wiper, and a second control bar configured to rotate about a fourth pivot spaced apart from the third pivot, the second control bar having an actuator for association with the deflector;
wherein, in an initial position the two wiper blades are substantially parallel, and when in motion, the two wiper blades travel in opposite directions;
wherein the first pivot and the third pivot are each positioned between the second pivot and the fourth pivot such that in the initial position the inner and outer blades of each wiper blade are substantially co-planar and in a second position the outer blade of each wiper blade is bent relative to the inner blade.

3. The windshield wiper system according to claim 2, wherein each wiper blade sweeps an angle between about 100 and about 130 degrees about their respective pivots.

4. The windshield wiper system according to claim 2, wherein in the second position the outer blade forms an angle with the inner blade of about 140 to about 175 degrees.

5. The windshield wiper system according to claim 1, wherein the wiper system is a tandem type wiper system further comprising:
a second wiper blade configured to rotate on a third pivot, and a second control bar configured to rotate on a fourth pivot spaced from the third pivot;
wherein the first and second pivots are spaced apart along the lateral direction, with the second pivot spaced outwardly away from the third and fourth pivots;
wherein the third and fourth pivots are spaced apart along the vertical or longitudinal directions with the third pivot above or rearward of the fourth pivot;
wherein, in an initial position the first and second wiper blades are substantially parallel, and when in motion, the first and second wiper blades travel in the same direction.

6. The windshield wiper system according to claim 1, wherein the first pivot is offset from the second pivot such that the wiper blade is configured to sweep an angle of approximately 180 degrees,
such that the actuator provides the greatest force on the deflector at both an initial position, and at a most-extended position approximately 180 degrees from the initial position.

7. The windshield wiper system according to claim 1, wherein the first pivot is spaced apart from the second pivot by between about 1 and about 20 cm.

8. A vehicle comprising:
a passenger cabin;
a windshield;
a windshield wiper system; and
at least one motor for operating the windshield wiper system,
wherein the windshield wiper system comprises:
a wiper blade configured to rotate about a first pivot, the wiper blade including an inner blade hinged to an outer blade, the inner and outer blade supporting a flexible wiper, a deflector formed on the outer blade; and
a control bar configured to rotate about a second pivot spaced from the first pivot, the control bar having an actuator capable of engaging with the deflector,
wherein the actuator translates relative to the deflector such that the actuator selectively applies a force to the deflector during rotation of the wiper blade and control bar causing a torque about the hinge, the torque allowing the outer blade to follows the contour of a windshield.

9. The vehicle according to claim 8, further comprising:
a second wiper blade configured to rotate about a third pivot, the second wiper blade having an inner blade hinged to an outer blade having a deflector, the inner blade and outer blade supporting a flexible wiper, and a second control bar configured to rotate about a fourth pivot spaced apart from the third pivot, the second control bar having an actuator for association with the deflector;
wherein, in an initial position the two wiper blades are substantially parallel, and when in motion, the two wiper blades travel in opposite directions;
wherein the first pivot and the third pivot are each positioned between the second pivot and the fourth pivot such that in the initial position the inner and outer blades of each wiper blade are substantially co-planar and in a second position the outer blade of each wiper blade is bent relative to the inner blade.

10. The vehicle according to claim 9, wherein each wiper blade sweeps an angle between about 100 and about 130 degrees about their respective pivots.

11. The vehicle according to claim 9, wherein in the second position the outer blade forms an angle with the inner blade of about 140 to about 175 degrees.

12. The vehicle according to claim 8, wherein the wiper system is a tandem type wiper system further comprising:
a second wiper blade configured to rotate on a third pivot, and a second control bar configured to rotate on a fourth pivot spaced from the third pivot;
wherein the first and second pivots are spaced apart along the lateral direction, with the second pivot spaced outwardly away from the third and fourth pivots;
wherein the third and fourth pivots are spaced apart along the vertical or longitudinal directions with the third pivot above or rearward of the fourth pivot;
wherein, in an initial position the first and second wiper blades are substantially parallel, and when in motion, the first and second wiper blades travel in the same direction.

13. The vehicle according to claim 8, wherein the first pivot is offset from the second pivot such that the wiper blade is configured to sweep an angle of approximately 180 degrees,
such that the actuator provides the greatest force on the deflector at both an initial position, and at a most-extended position approximately 180 degrees from the initial position.

14. The vehicle according to claim 8, wherein the first pivot is spaced apart from the second pivot by between about 1 and about 20 cm.
